(19) United States
(12) Patent Application Publication
(10) Pub. No.: US 2005/0128192 A1
(43) Pub. Date: Jun. 16, 2005

(54) Modifying visual presentations based on environmental context and user preferences

(75) Inventors: Douglas Heintzman, Pleasantville, NY (US); Richard S. Schwerdtfeger, Round Rock, TX (US); Lawrence F. Weiss, Round Rock, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/734,772

(22) Filed: Dec. 12, 2003

(51) Int. Cl. G09G 5/00

(52) U.S. Cl. 345/207

(57) ABSTRACT

The present invention provides a method and an apparatus for modifying visual presentations based on environmental context, display characteristics, and user preferences. The apparatus includes an interface and a controller coupled to the interface. The controller is adapted to receive data indicative of light conditions proximate to a visual presentation device, receive data associated with at least one visibility profile, and determine visual data to be displayed by the visual presentation device based on at least a portion of the received data indicative of light conditions and the received data associated with the at least one visibility profile.

### BACKGROUND OF THE INVENTION

1. Field of the Invention

This invention relates generally to visual presentation systems, and, more particularly, to modifying visual presentations based on environmental context and user preferences.

2. Description of the Related Art

The increase in utility and availability of various information technology services has led to a corresponding proliferation of devices for accessing these services via, e.g., wired and wireless networks. For example, desktop computers, laptop computers, personal data assistants, cell phones, navigation systems, and the like may be coupled to a variety of information technology services via wired and/or wireless networks such as the World Wide Web, wide area networks, local area networks, and the like. Although these devices may share the same networks, not all the devices, or even all models or versions of the same device, may be capable of displaying information in the same format.

Consequently, the information technology industry is working toward being able to provide information to a particular device in a format that is appropriate to the device. In one approach, a profile indicating one or more device preferences may be provided to a server. The server may then use the profile to transform information to a format appropriate for the device. For example, a Composite Capabilities/Preferences Profile (often referred to as a CC/PP) may be used to pass information regarding the capabilities and/or preferences of a particular device. When the device requests information from a server, the server, or an intermediary, may access the profile to determine the appropriate format for information that may be transmitted to the device.

Visual presentation of information poses a unique set of challenges for these so-called on-demand solutions. For example, the visibility of information presented on display screens in pervasive devices such as cell phones, personal data assistants, and the like may be affected by the environment. The intensity and/or color of ambient light may change as a user carries the pervasive device from one context to another, and the visibility of the information displayed on the display screen may therefore change. The visibility of information displayed by non-pervasive devices may also be affected by changing environmental conditions, such as the rising and setting of the sun, the presence or absence of artificial lighting, and the like.

The parameters used to display visual information typically assume an average user working in a predetermined environmental context. For example, a conventional desktop computer may display text under the assumption that the user has 20/20 corrected vision and is working in an office under fluorescent lights. To compensate for small variations in the environmental conditions, users may be provided with various devices to manually adjust the parameters of the display device. For example, a computer monitor coupled to a conventional desktop computer may include adjustment devices such as a brightness control, a contrast control, and the like. However, finding and/or adjusting these controls may be awkward and inconvenient for the user. Moreover, the small size of many pervasive devices may make it difficult to include the adjustment devices in a convenient location.

The visibility of information may also be affected by deficiencies in the user's eyesight. One user may be near-sighted, while another may be far-sighted. Although these conditions may be corrected, users may want to use the device when their corrective lenses are unavailable. In addition, the eyesight of some users may have deteriorated beyond a fully correctable level. Furthermore, as users age, the lenses of their eyes may yellow and/or crystallize, which may result in increased light absorption by the lens. Aging users may also experience reduced pupil size and/or increased light scatter from the lens. These and similar problems may be frequency-dependent and may result in reduced light and/or contrast sensitivities, reduced color discrimination, reduced acuity, and the like. Consequently, the user may experience a dimmer, lower contrast visual world, with less vivid colors, poor night vision, blurred vision, reading problems, and the like. These conditions may make it difficult for the user to view information displayed on a conventional display device, which may impair the user's ability to access information using the associated device and/or network.

### SUMMARY OF THE INVENTION

In one aspect of the instant invention, a method is provided for modifying visual presentations based on environmental context and user preferences. The method includes receiving data indicative of light conditions proximate to a visual presentation device, receiving data associated with at least one visibility profile, and determining visual data to be displayed by the visual presentation device based on at least a portion of the received data indicative of light conditions and the received data associated with the at least one visibility profile. An apparatus including an interface coupled to a controller adapted to perform the aforementioned method, as well as an article comprising one or more machine-readable storage media containing instructions that when executed enable a processor to implement the method, are also provided.

### BRIEF DESCRIPTION OF THE DRAWINGS

The invention may be understood by reference to the following description taken in conjunction with the accompanying drawings, in which like reference numerals identify like elements, and in which:

FIG. 1 illustrates one embodiment of a system including various devices for displaying visual information that are communicatively coupled to a processor-based device.

FIG. 2 conceptually illustrates one embodiment of a system including a display device, such as the display devices shown in FIG. 1.

FIGS. 3A and 3B conceptually illustrate visual information displayed under high and low brightness conditions, respectively, in accordance with one embodiment of the present invention.

FIG. 4 conceptually illustrates one embodiment of a method of modifying visual presentations based upon environmental context and user preferences.

FIG. 5 shows a stylized block diagram of a system that may be implemented in the system of FIG. 1, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

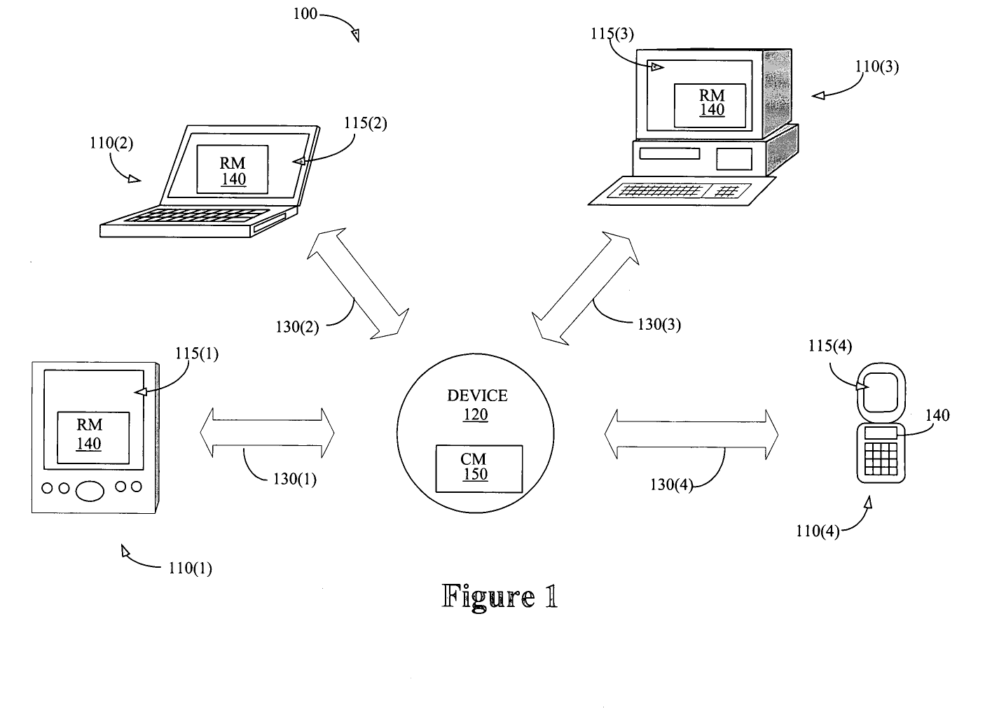

FIG. 1 shows a system 100 including various devices 110(1-4) for displaying visual information. In various alternative embodiments, the devices 110(1-4) may include one or more pervasive and/or non-pervasive devices. For example, the devices 110(1-4) may include a personal data assistant 110(1), a laptop computer 110(2), a desktop computer 110(3), a cellular telephone 110(4), and the like. However, persons of ordinary skill in the art will appreciate that, in alternative embodiments, the devices 110(1-4) may include other devices capable of displaying visual information, such as global positioning systems, automobile navigation systems, projection devices, televisions, and the like. Moreover, any desirable number and combination of the devices 110(1-4) may be included in the system 100.

Each of the devices 110(1-4) includes a display device 115(1-4) that is capable of displaying information visually. For example, the display devices 115(1-4) may be flat panel LED displays, CRTs, and the like. The various display devices 115(1-4) may have different display capabilities. For example, the display devices 115(1-4) may be capable of presenting visual information in black and white and/or a predetermined number of colors. The display devices 115(1-4) may also be capable of presenting visual information using a variety of brightnesses, contrasts, magnifications, fonts, animations, and the like.

Moreover, the size, display or glass reflectivity, and/or resolution of the display devices 115(1-4) may vary. For example, the display devices 115(2-3) included in the laptop computer 110(2) and the desktop computer 110(3) may be substantially larger and have substantially more pixels than the display devices 115(1), 115(4) included in the personal data assistant 110(1) and the cellular telephone 110(4). Consequently, the display devices 115(2-3) included in the laptop computer 110(2) and the desktop computer 110(3) may be capable of displaying larger images at higher resolution. For another example, a high display or glass reflectivity may cause the display devices 115(1-4) to be more susceptible to glare from ambient light. In one embodiment, the aforementioned capabilities and characteristics of the display devices 115(1-4) may be stored in a visibility profile.

The devices 110(1-4) are communicatively coupled to a processor-based device 120 by respective links 130(1-4). In various alternative embodiments, the links 130(1-4) may be any desirable combination of wired and/or wireless links 130(1-4). For example, the personal data assistant 110(1) may be communicatively coupled to the processor-based device 120 by an infrared link 130(1). For another example, the laptop computer 110(2) may be communicatively coupled to the processor-based device 120 by a wireless local area network (LAN) link 130(2). As yet another example, the desktop computer 110(3) may be communicatively coupled to the processor-based device 120 by a wired LAN connection 130(3), such as an Ethernet connection. As yet another example, the cellular telephone 110(4) may be communicatively coupled to the processor-based device 120 by a cellular network link 130(4). However, in alternative embodiments, any desirable mode of communicatively coupling the devices 110(1-4) and the processor-based device 120, including traces, wires, cables, radiofrequency links, satellite links, and the like, may be used.

The processor-based device 120 is capable of providing information to the devices 110(1-4). In the illustrated embodiment, the processor-based device 120 is a network server that is capable of receiving requests from, and transmitting information to, the devices 110(1-4). However, the present invention is not limited to network servers. In alternative embodiments, the processor-based device 120 may be a transcoder, a network hub, a network switch, and the like. Moreover, the processor-based device 120 may not be external to one or more of the devices 110(1-4). For example, the processor-based device 120 may be a processor (not shown) included in one or more of the devices 110(1-4) to perform the desired features. In another embodiment, some aspects of the processor-based device 120 may be implemented in the devices 110(1-4) while other aspects of the processor-based device 120 may be implemented elsewhere, external to the devices 110(1-4).

In one embodiment, the devices 110(1-4) may include a remote module 140, which may receive data indicative of light conditions proximate to the devices 110(1-4), respectively. The remote module 140 may also receive data associated with at least one visibility profile containing information indicative of the capabilities and characteristics of the devices 110(1-4), 115(1-4), as well as the preferences and/or capabilities of the user. For example, a federated identification may be used to identify and retrieve a visibility profile from a federated server. The remote module 140 may determine a format for information to be displayed by the device 110(1-4) on, for example, the display devices 115(1-4), respectively, based on at least a portion of the received data and the received visibility profile. In one embodiment, the visibility profile may include a user profile and a device profile, which may be stored in different locations.

The processor-based device 120 may, in one embodiment, include a controller module 150, which may receive data indicative of light conditions proximate to the devices 110(1-4), respectively. The controller module 150 may also receive data associated with at least one visibility profile and determine a format for information to be displayed by the device 110(1-4) on, for example, the display devices 115(1-4), respectively, based on at least a portion of the received data and the received visibility profile. The various modules 140, 150 illustrated in FIG. 1 are implemented in software, although in other implementations these modules may also be implemented in hardware or a combination of hardware and software.

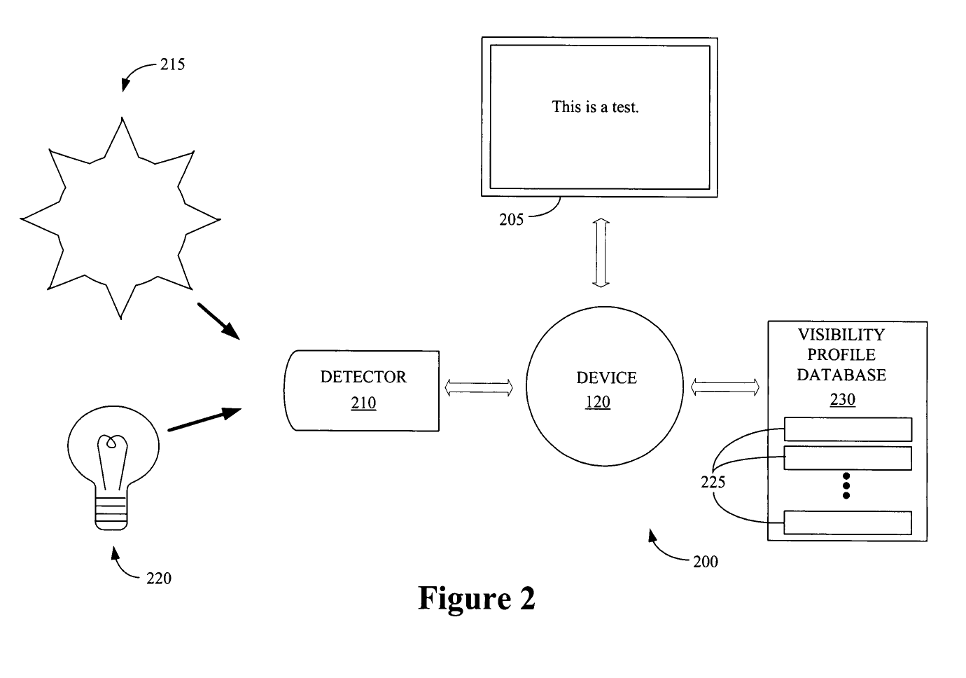

FIG. 2 conceptually illustrates one embodiment of a system 200 including a display device 205, such as the display devices 115(1-4) that may be used in the devices 110(1-4) shown in FIG. 1. In the illustrated embodiment of FIG. 2, the features of the processor-based device 120 may be integrated within the system 200, or, alternatively, may be implemented external to the system 200. The display device 205 is capable of displaying information transmitted by the processor-based device 120. For example, as shown in FIG. 2, the display device 205 may use information provided by the processor-based device 120 to visually present the phrase, “This is a test.” As discussed above, portions of the processor-based device 120 may be included in the device housing the display device 205, as well as external to the device housing the display device 205.

The system 200 includes a detector 210 that is capable of acquiring data indicative of light conditions proximate to the display device 205. For example, the detector 210 may be capable of measuring the intensity of ambient light from the sun 215 and/or an artificial light source 220. The detector 210 may also be capable of acquiring data indicative of other light conditions proximate to the display device 205 including, but not limited to, spectral and/or color information, angles of incidence and/or reflection, variability, and the like. The detector 210 provides the acquired data indicative of the light conditions proximate to the display device 205 to the processor-based device 120. In various alternative embodiments, the detector 210 may be a photovoltaic cell, a charge coupled device, and the like.

The system 200, in one embodiment, may have a plurality of users. In the illustrated embodiment, the plurality of users may each have an associated visibility profile 225 stored in a database 230, portions of which may be located at any desired location, including on the processor-based device 120 or another device. For example, the database 230 may be stored in a location remote to the processor-based device 120. The processor-based device 120 may access the one or more visibility profiles 225 that contain information that can be used by the processor-based device 120 to provide information to the display device 205 in a manner desired by the user. In one embodiment, the visibility profiles 225 may be an extended version of Composite Capabilities/Preferences Profiles that may be stored at any desirable location. In one alternative embodiment, the visibility profiles 225 may be an extended version of a Learner Profile. A conventional Learner Profile is defined by the IMS Learner Information Package (LIP) specification version 1.0.

In one embodiment, the visibility profiles 225 include information about the capabilities of the particular device being used by the user, such as the display devices 115(1-4) shown in FIG. 1. For example, the visibility profiles 225 may indicate that the display device 205 is a black-and-white display or a color display, how many colors are available, the range of contrasts and brightnesses, the physical dimensions of the display device 205, the number of pixels, the reflectivity of the glass or display, and other parameters related to the capabilities of the display device 205. In addition, the visibility profiles 225 may indicate the preferred mode of operation of the display device 205. For example, the visibility profiles 225 may indicate that a default mode of operation of the display device 205 preferentially displays information in black-and white using a 12-pt Times New Roman text font on a 17-inch screen having 1200×800 pixels. In one embodiment, the visibility profiles 225 may include a separate device profile containing information about the capabilities of the particular device.

The visibility profiles 225 may also include information specific to one or more users. In one embodiment, the user information may include the user's preferences. For example, a first visibility profile 225 may indicate that a first user prefers to have information displayed in color using an 18-pt Arial text font on a 15-inch screen having 1200×800 pixels. A second user, however, may have an associated visibility profile 225 indicating that the second user prefers to have information displayed in color using a 10-pt Webdings font on a 21-inch screen having 1200×800 pixels. In one embodiment, the visibility profiles 225 may be edited or modified by the user.

The visibility profiles 225 may also include information about the user's capabilities. In particular, the visibility profiles 225 may include information indicating any limitations in the user's visual capabilities that may impact the user's ability to see visual information presented on the display device 205. For example, the visibility profile 225 may indicate that the user is color blind, or is not sensitive to colors in particular portions of the visible spectrum. Alternatively, the visibility profile 225 may indicate that the user's eyes have yellowed and/or crystallized, or that the user has reduced pupil size and/or increased light scatter from the lens. In one embodiment, the user may establish the visibility profile 225 indicating the user's capabilities by providing the relevant information. Alternatively, a doctor may test the user's eyesight and form the visibility profile 225 based on the test results or an automated testing system may be used to establish the visibility profile 225.

Although the embodiment of the visibility profile 225 shown in FIG. 2 includes information associated with both the user and the display device 205, the present invention is not so limited. In alternative embodiments, portions of the visibility profile 225 corresponding to the user's preferences and/or capabilities and the characteristics and/or capabilities of the display device 205 may be separate entities. For example, the visibility profile database 230 may include one or more user profiles associated with the portion of the visibility profile 225 corresponding to the user's preferences and/or capabilities, and one or more device profiles corresponding to the portion of the visibility profile 225 associated with the characteristics and/or capabilities of the display device 205.

As the conditions proximate to the display device 205 change, the visual information displayed may become more difficult to see. For example, if a user is reading a document on a personal data assistant while walking from a dark room to a lighted room, the ambient light in the lighted room may obscure the visual information displayed on the display device 205 of the personal data assistant. Alternatively, the user of the display device 205 may change, making the current visual presentation preferences undesirable. For example, a first user may log off a desktop computer, which may be displaying information using the first user's preferences, e.g., a low contrast color display, as indicated in a visibility profile 225. A second user requiring or preferring a high contrast black-and-white display may then log on to the desktop computer.

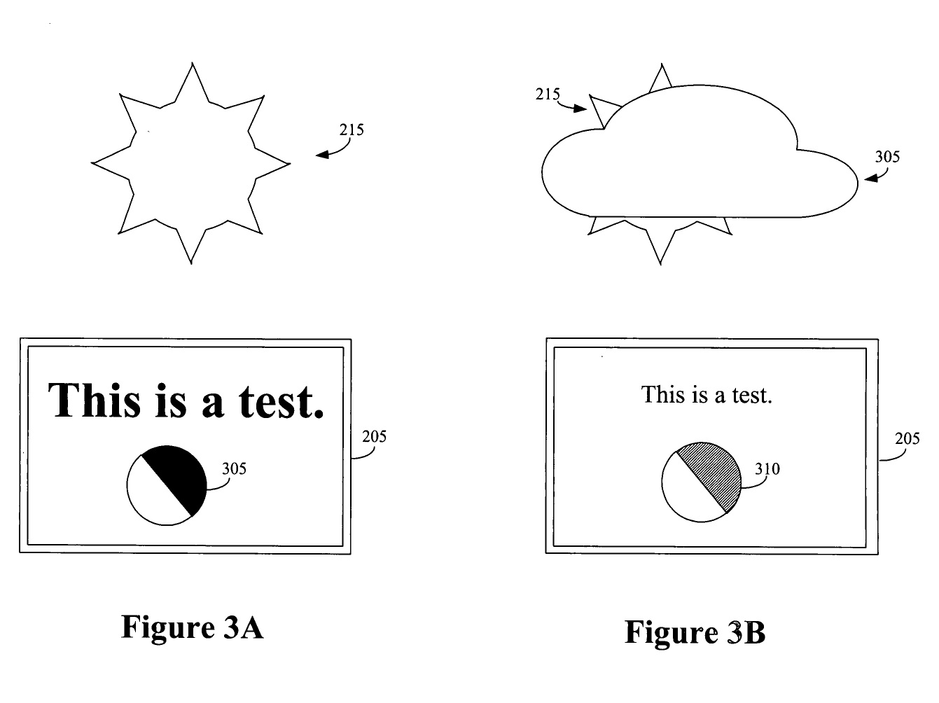

Turning to FIGS. 3A and 3B, in accordance with one embodiment of the present invention, the processor-based device 120 receives the data acquired by the detector 210 and the visibility profiles 225, and, based on the received data, determines a format for information to be displayed by the visual presentation device 205. For example, a visibility profile 225 may indicate that a user prefers larger fonts and higher contrast in bright light. Thus, the processor-based device 120 may use the data stored in the visibility profile 225 and the data provided by the detector 210 to determine a format that may be used to present information in larger fonts (i.e. the phrase, “This is a test.”) and at higher contrast (as indicated by the split circle 305) when bright light from the sun 215, and the resulting glare, make it difficult for the user to see visual information, as shown in FIG. 3A. When the ambient light intensity is lower, such as when a cloud 305 passes over the sun 215, the processor-based device 120 may use the accessed visibility profile 225 and the data acquired by the detector 210 to determine a format to present information in smaller fonts (i.e. the phrase, “This is a test.”) and at lower contrast (as indicated by the split circle 310), as shown in FIG. 3B.

A plurality of users may have access to the same display device 205. A first visibility profile 225 may indicate that a first user prefers a format that allows the display device 205 to present information in smaller fonts (i.e. the phrase, “This is a test.”, shown in FIG. 3B) and at lower contrast (as indicated by the split circle 310). However, a second visibility profile 225 may indicate that a second user prefers larger fonts and higher contrast. Thus, when a second user is detected using the display device 205 (e.g., the second user has logged in), the processor-based device 120 receives the data acquired by the detector 210 and the visibility profiles 225, and, based on the received data, determines a format for information to be displayed by the visual presentation device 205. For example, the processor-based device 120 may use the data stored in the visibility profile 225 and the data provided by the detector 210 to modify the format so that it may be used to present information in a manner desired by the second user, i.e. in larger fonts (i.e. the phrase, “This is a test.”) and at higher contrast (as indicated by the split circle 305), as shown in FIG. 3A.

Persons of ordinary skill in the art having benefit of the present disclosure will appreciate that the potential data acquired by the detector 210 and the possible contents of the visibility profiles 225 may vary greatly depending on the application and context in which the present invention is practiced and it would therefore be impractical to list all the types of data that may be acquired and all the features that may be entered into the visibility profiles 225. Moreover, the possible display formats that may be determined by the processor-based device 120 using the data received by the detector 210 and the data received from the visibility profile 225 may also vary from one implementation to another. In the interest of clarity, the above discussion of the capabilities of the system 200 is limited to a few illustrative embodiments that are intended to be exemplary of the manner in which the present invention may be practiced. The aforementioned embodiments are not, however, intended to limit the present invention.

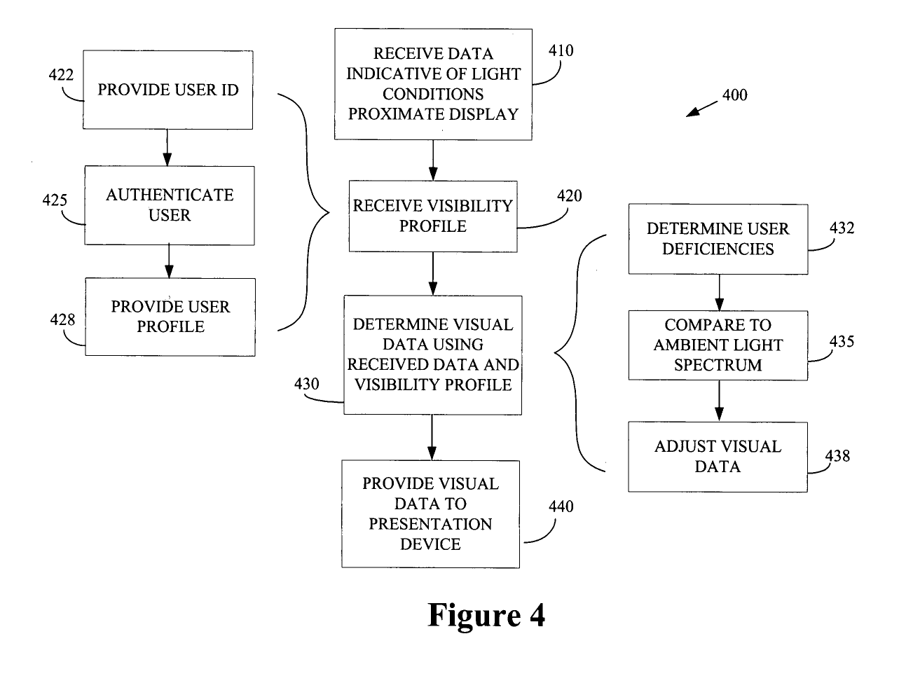

FIG. 4 conceptually illustrates one embodiment of a method 400 of modifying visual presentations based upon environmental context, display characteristics, and user preferences. In one embodiment, the processor-based device 120 receives (at 410) data indicative of light conditions proximate to a visual presentation device, such as the display devices 115(1-4), 205 shown in FIGS. 1, 2, 3A, and 3B. For example, the processor-based device 120 may receive (at 410) data acquired by a photosensitive device, such as a photovoltaic cell or a charge coupled device, which may be deployed proximate to the visual presentation device. The processor based device 120 may, in one embodiment, determine an intensity of the ambient light and/or a spectrum of the ambient light.

The processor-based device 120 also receives (at 420) at least one visibility profile, such as the visibility profiles 225 shown in FIG. 2. In one embodiment, the processor-based device 120 receives (at 420) the visibility profiles, such as the visibility profiles 225, by accessing a visibility profile database, such as the visibility profile database 230 shown in FIG. 2. In one embodiment, the visibility profile database is stored on a remote server (not shown) and may be accessed by providing (at 422) a user identification number or other indications of the user, such as a name, a username or alias, a password, and the like. For example, a federated identification number, such as may be included in a Microsoft Passport®, associated with the user may be used to access the visibility profile stored on a federated server. The user is then authenticated (at 425) using the user identification and a user profile is provided (at 428) to the processor based device 120 by the remote server.

The processor-based device 120 determines (at 430) visual data to be displayed by the visual presentation device using the received data and the received visibility profile. In one embodiment, the processor based device 120 determines (at 432) one or more deficiencies in the user's vision using the user profile. For example, the processor-based device 120 may determine (at 432) that the user experiences light scatter when viewing text on a white background. In one embodiment, the visibility profile, or an associated device profile, may indicate that the light scatter may be exacerbated by glare from the device. The processor-based device 120 may then compare (at 435) the determined deficiencies to the ambient light spectrum and then adjust (at 438) the visual data accordingly. For example, if the ambient light is likely to cause glare that may make it difficult for the user prone to light scatter to read text on the device, the processor-based device 120 may adjust (at 438) the visual data to enhance the visibility of the text. For example, the processor-based device 120 may adjust (at 438) the visual data to change the background from white to dark gray. The foreground color, brightness, contrast, size, font, and other characteristics of the visual data may also be adjusted (at 438).

The processor-based device 120 then provides (at 440) the visual data to the visual presentation device. In one embodiment, the processor-based device 120 may request information from a remote server and then provide (at 440) the requested information to the visual presentation device using the determined display format. For example, the processor-based device 120 may provide (at 440) text on a dark gray background, in a different color, with enhanced contrast, or in a different font or size.

As noted earlier, in one embodiment, the device 120 may be located remotely from the visual presentation device. The device 120 may, for example, be a server or a proxy server. In such an embodiment, the remotely located device 120 may perform one or more of the acts described in FIG. 4, including determining (at 430) the visual data, and then providing (at 440) a signal indicative of the determined visual data to the visual presentation device. The visual data may be determined (at 430) based on at least a portion of the light condition(s) and at least a portion of the visibility profile that are accessible (or provided) to the remotely located device 120.

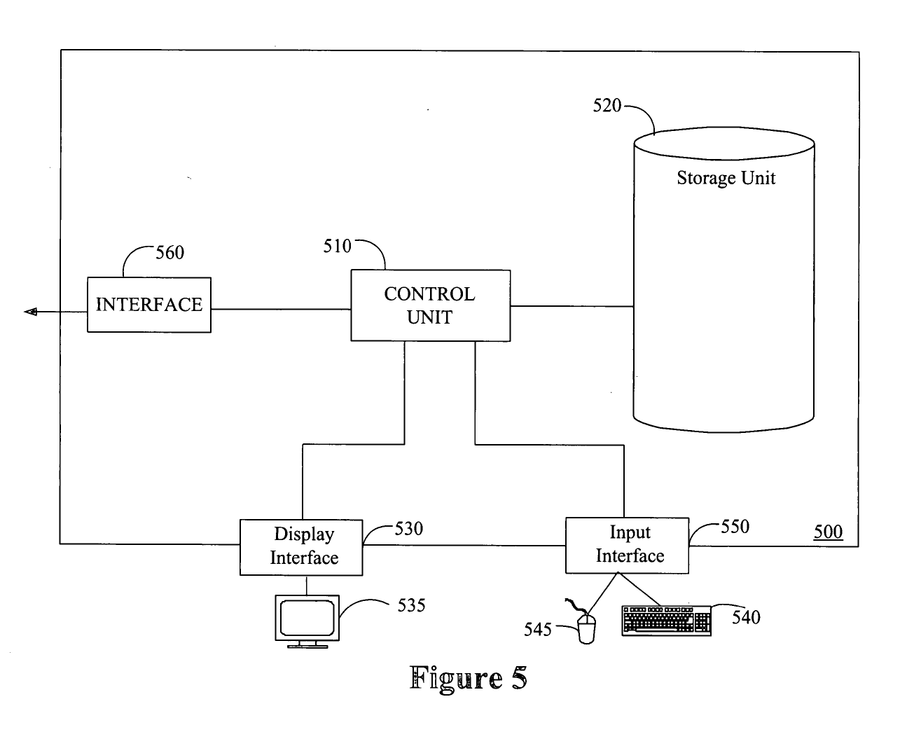

FIG. 5 shows a stylized block diagram of a processor-based system 500 that may be implemented in the system 100 shown in FIG. 1, in accordance with one embodiment of the present invention. In one embodiment, the processor-based system 500 may represent portions of one or more of the devices 110(1-4) and/or the processor-based device 120 of FIG. 1, with the system 500 being configured with the appropriate software configuration or configured with the appropriate modules 140, 150 of FIG. 1.

The system 500 comprises a control unit 510, which in one embodiment may be a processor that is communicatively coupled a storage unit 520. The software installed in the storage unit 520 may depend on the features to be performed by the system 500. For example, if the system 500 represents one of the devices 110(1-4), then the storage unit 520 may include the module 140. The modules 140, 150 may be executable by the control unit 510. Although not shown, it should be appreciated that in one embodiment an operating system, such as Windows Disk Operating System®, Unix®, OS/2®, Linux®, MAC OS®, or the like, may be stored on the storage unit 520 and be executable by the control unit 510. The storage unit 520 may also include device drivers for the various hardware components of the system 500.

In the illustrated embodiment, the system 500 includes a display interface 530. The system 500 may display information on a display device 535, such as the display devices 115(1-4) shown in FIG. 1, via the display interface 530. In the illustrated embodiment, a user may input information using an input device, such as a keyboard 540 and/or a mouse 545, through an input interface 550. Although not shown in FIG. 5, the system 500 may also include a detector, such as the detector 210 shown in FIG. 2.

The control unit 510 is coupled to a network interface 560, which may be adapted to receive, for example, a local area network card. In an alternative embodiment, the network interface 560 may be a Universal Serial Bus interface or an interface for wireless communications. The system 500 communicates with other devices through the network interface 560. For example, the control unit 510 may receive one or more visibility profiles 225 from a visibility profile database 230 stored in a remote storage medium (not shown) via the interface 560. Although not shown, associated with the network interface 560 may be a network protocol stack, with one example being a UDP/IP (User Datagram Protocol/Internet Protocol) stack or Transmission Control Protocol/Internet Protocol. In one embodiment, both inbound and outbound packets may be passed through the network interface 560 and the network protocol stack.

It should be appreciated that the block diagram of the system 500 of FIG. 5 is exemplary in nature and that in alternative embodiments, additional, fewer, or different components may be employed without deviating from the spirit and scope of the instant invention. For example, if the system 500 is a computer, it may include additional components such as a north bridge and a south bridge. In other embodiments, the various elements of the system 500 may be interconnected using various buses and controllers. Similarly, depending on the implementation, the system 500 may be constructed with other desirable variations without deviating from the spirit and scope of the present invention.

The various system layers, routines, or modules may be executable control units, such as the control unit 510. The control unit 510 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 515 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
receiving data indicative of light conditions proximate to a visual presentation device;
receiving data associated with at least one visibility profile; and
determining visual data to be displayed by the visual presentation device based on at least a portion of the received data indicative of the light conditions and at least a portion of the received data associated with the at least one visibility profile.

2. The method of claim 1, wherein receiving the data indicative of light conditions proximate to the visual presentation device comprises determining at least one of an ambient light intensity and an ambient light spectrum.

3. The method of claim 2, wherein receiving the at least one visibility profile comprises receiving an indication of at least one deficiency in vision of a user.

4. The method of claim 3, wherein determining visual data to be displayed by the visual presentation device comprises comparing the indication of the at least one vision deficiency and at least one of the ambient light intensity and the ambient light spectrum.

5. The method of claim 4, wherein determining the visual data comprises determining at least one of a desired background color, foreground color, brightness, contrast, size, and font.

6. The method of claim 1, further comprising requesting the information to be displayed on the visual presentation device from a remote server.

7. The method of claim 1, wherein receiving the visibility profile comprises receiving at least one of a user profile and a device profile, and receiving the visibility profile comprises receiving at least one of a Composite Capabilities/Preferences Profile and a Learner Profile.

8. The method of claim 1, wherein determining the visual data to be displayed by the visual presentation device comprises determining the visual data using a processor-based device located remotely from the presentation device and providing the visual data from the processor-based device to the visual presentation device.

9. The method of claim 8, wherein requesting the information comprises providing at least one of a user identification number, a name, a username, an alias, a federated identification, and a password to the remote server.

10. The method of claim 1, further comprising determining that a new user is using the visual presentation device and receiving the visibility profile in response to determining that the new user is using the visual presentation device.

11. An apparatus, comprising:
an interface; and
a control unit communicatively coupled to the interface and adapted to:
receive data indicative of light conditions proximate to a visual presentation device;
receive data associated with at least one visibility profile; and
determine visual data to be displayed by the visual presentation device based on at least a portion of the received data indicative of light conditions and at least a portion of the received data associated with the at least one visibility profile.

12. The apparatus of claim 11, wherein the control unit is adapted to determine at least one of an ambient light intensity and an ambient light spectrum.

13. The apparatus of claim 12, wherein the control unit is adapted to receive an indication of at least one deficiency in vision of a user.

14. The apparatus of claim 13, wherein the control unit is adapted to compare the indication of at least one deficiency in the vision of the user and at least one of the ambient light intensity and the ambient light spectrum.

15. The apparatus of claim 14, wherein the control unit is adapted to determine at least one of a desired background color, foreground color, brightness, contrast, size, and font.

16. The apparatus of claim 11, further comprising at least one visual presentation device adapted to display the determined visual data.

17. The apparatus of claim 16, wherein the visual presentation device is at least one of a personal data assistant, a laptop computer, a desktop computer, a cellular telephone, a global positioning system, an automobile navigation system, a projection device, and a television.

18. The apparatus of claim 11, further comprising at least one detector for acquiring the data indicative of light conditions proximate to the at least one visual presentation device.

19. An apparatus, comprising:
means for receiving data indicative of light conditions proximate to a visual presentation device;
means for receiving data associated with at least one visibility profile; and
means for determining visual data to be displayed by the visual presentation device based on at least a portion of the received data indicative of light conditions and at least a portion of the data associated with the at least one visibility profile.

20. A system, comprising:
at least one visual presentation device adapted to display visual data;
at least one storage device adapted to store at least one visibility profile;
at least one detector for acquiring data indicative of light conditions proximate to the at least one visual presentation device; and
a processor-based device adapted to:
receive the data indicative of light conditions proximate to the visual presentation device;
receive data associated with at least one visibility profile; and
determine the visual data to be displayed by the visual presentation device based on at least a portion of the received data indicative of light conditions and at least a portion of the received data associated with the at least one visibility profile.

21. The system of claim 20, wherein the visual presentation device is at least one of a personal data assistant, a laptop computer, a desktop computer, a cellular telephone, a global positioning system, an automobile navigation system, a projection device, and a television.

22. The system of claim 20, further comprising a plurality of visual presentation devices.

23. The system of claim 20, further comprising a plurality of detectors deployed proximate to the plurality of visual presentation devices.

24. The system of claim 20, wherein the at least one storage device is adapted to store at least one user profile database containing the at least one user profile, and wherein the visibility profile comprises at least one of a user profile and a device profile.

25. A computer program product in a computer readable medium which when executed by a processor performs the steps comprising:
receiving the data indicative of light conditions proximate to the visual presentation device;
receiving data associated with at least one visibility profile; and
determining visual data to be displayed by the visual presentation device based on at least a portion of the received data indicative of light conditions and at least a portion of the received data associated with the at least one visibility profile.

26. The product of claim 25, wherein the computer program product when executed by the processor performs the steps comprising determining at least one of an ambient light intensity and an ambient light spectrum.

27. The product of claim 25, wherein the computer program product when executed by the processor performs the steps comprising receiving an indication of at least one deficiency in a user's vision.

28. The product of claim 25, wherein the computer program product when executed by the processor performs the steps comprising comparing the indication of at least one deficiency in vision of a user and at least one of the ambient light intensity and the ambient light spectrum.

29. The product of claim 25, wherein the computer program product when executed by the processor performs the steps comprising determining at least one of a desired background color, foreground color, brightness, contrast, size, and font.
